(19) United States
(12) Patent Application Publication
(10) Pub. No.: US 2010/0073779 A1
(43) Pub. Date: Mar. 25, 2010

(54) LENS SYSTEM

(75) Inventors: KUANG-JU WANG, Tu-Cheng (TW); CHUN-HSIANG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,396

(22) Filed: Dec. 9, 2008

(30) Foreign Application Priority Data
Sep. 25, 2008 (CN) 200810304661.8

(51) Int. Cl. G02B 13/18; G02B 9/34

(52) U.S. Cl. 359/715; 359/772

(57) ABSTRACT

A lens system includes, in order from the object side, a positive refractive power first lens, a negative refractive power second lens, a positive refractive power third lens, and a fourth lens. Wherein the lens system satisfies the following conditions: (1) TTL/f<1.3; and (2) 0.75<f1/f<1.25, wherein, TTL is a distance from a surface of the first lens facing the object side of the lens system to the image plane, f is a focal length of the lens system, and f1 is a focal length of the first lens.

### TECHNICAL FIELD

The present invention relates to a lens system and, particularly, to a compact lens system having a small number of lens components and a short overall length.

### DESCRIPTION OF THE RELATED ART

Conventionally, there is a technical field of lenses where a short overall length is demanded for use in lens modules for image acquisition that are mounted in relatively compact equipment, such as simple digital cameras, webcams for personal computers, and portable imaging systems in general. In order to satisfy this demand, conventional imaging lenses have been formed using a one-piece lens construction. Because the electronic image sensing chips used with the lens modules are compact and have low resolution, maintaining a small image size on the image sensing chips and miniaturizing the lens systems with a small number of lens components has been a priority. In those arrangements, even with one-piece lens construction, aberrations are acceptable and the incident angle of light rays onto the image sensing chip is usually not so large as to be a problem.

However, in recent years, because the resolution and the size of the image sensing chips have increased, aberrations occurring in one-piece lenses now becomes too large in use with the improved images sensing chips to achieve the desired optical performance. Therefore, it has become necessary to develop a lens system with a short overall length and an optical performance that matches image sensing chips with enhanced resolution and size.

What is needed, therefore, is a lens system with a short overall length and with relatively good optical performance.

### BRIEF DESCRIPTION OF THE DRAWINGS

Many aspects of the present lens system can be better understood with reference to the following drawings. The components in the drawings are not necessarily drawn to scale, the emphasis instead being placed upon clearly illustrating the principles of the present lens system. Moreover, in the drawings, like reference numerals designate corresponding parts throughout the several views.

FIG. 1 is a schematic view of a lens system according to an embodiment.

FIGS. 2-4 are graphs respectively showing field curvature, distortion and spherical aberration for a lens system according to a first exemplary embodiment of the present invention.

FIGS. 5-7 are graphs respectively showing field curvature, distortion and spherical aberration for a lens system according to a second exemplary embodiment of the present invention.

### DETAILED DESCRIPTION OF THE EMBODIMENTS

Embodiments of the present disclosure will now be described in detail below, with references to the accompanying drawings.

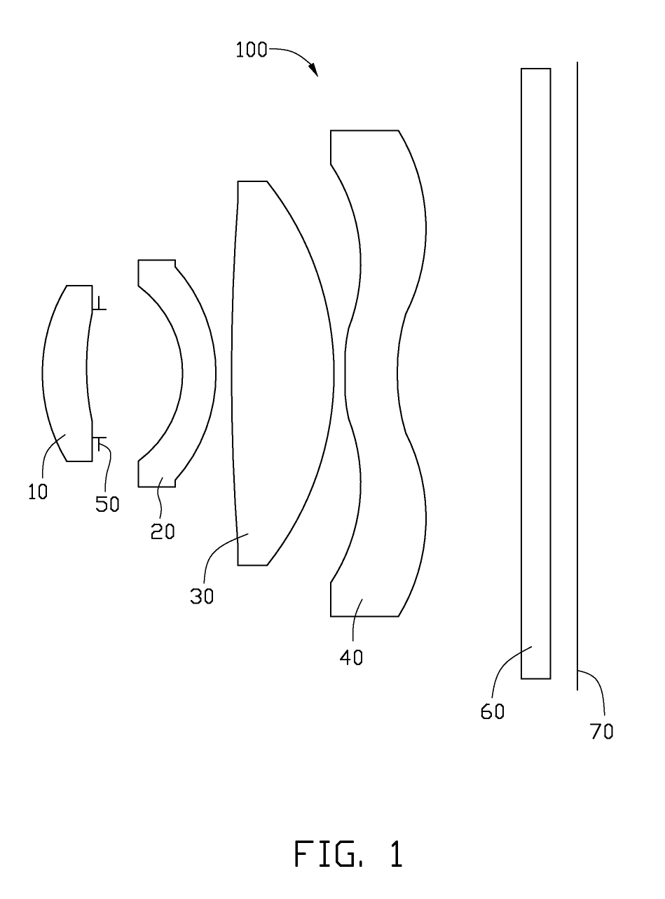

Referring to FIG. 1, a lens system 100, according to an embodiment, is shown. The lens system 100 includes, in order from the object side to the image side, a positive refractive power first lens 10, a negative refractive power second lens 20, a positive refractive power third lens 30, and a fourth lens 40. The lens system 100 can be used in digital cameras, mobile phones, personal computer cameras and so on. The lens system 100 can be used for capturing images by disposing an image sensor at an image plane 70 of the lens system 100.

In order that the lens system 100 has a short overall length and low spherical aberration, the lens system 100 satisfies the following conditions:

TTL/f<1.3; and (1)

0.75<f1/f<1.25, (2)

wherein, TTL is a distance from a surface of the first lens 10 facing the object side of the lens system 100 to the image plane 70, f is a focal length of the lens system 100, and f1 is a focal length of the first lens 10. The first condition (1) is for limiting the overall length of the lens system 100 by providing the relationship between the overall length of the lens system 100 and the focal length of the lens system 100. The second condition (2) is for decreasing spherical aberration of the lens system 100 by limiting the relationship between the focal length of the first lens 10 and the focal length of the lens system 100. In the present embodiment, the first lens 10 is a meniscus-shaped lens with a convex surface facing the object side of the lens system 100 and the two surfaces of the first lens 10 are aspherical.

The first lens 10 also satisfies the following condition:

V1>50, (3)

wherein, V1 is the Abbe constant of the first lens 10. The third condition (3) is for ensuring the light from an object has low chromatic aberration after transmitting through the first lens 10 to decrease the chromatic aberration of the lens system.

The second lens 20 also satisfies the following condition:

n2>1.58, (4)

wherein, n2 is the refractive index of second lens 20. The fourth Condition (4) is for ensuring the second lens 20 has a relative high refractive index to increase the field angle of the light transmitting through the second lens 20. In the present embodiment, the second lens 20 is a meniscus-shaped lens with a convex surface facing the image side of the lens system 100 and the two surfaces of the second lens 20 are aspherical.

The second lens 20 further satisfies the following condition:

0.9<|f2/f1<2.2, (5)

wherein, f2 is a focal length of the second lens 20. The fifth condition (5) is for decreasing spherical aberration and coma of the lens system 100 by limiting the relationship between the focal length of the second lens 20 and the focal length of the lens system 100.

The third lens 30 also satisfies the following condition:

0.8<f3/f<1.6, (6)

wherein, f3 is a focal length of the third lens 30. The sixth condition (6) is for decreasing spherical aberration and coma of the lens system 100 by limiting the relationship between the focal length of the third lens 30 and the focal length of the lens system 100. In the present embodiment, the third lens 30 is a biconvex lens and the two surfaces of the third lens 30 are aspherical.

In the present embodiment, the lens surface configuration of the fourth lens 40 near the optical axis of the lens system 100 is meniscus-shaped with a convex surface facing the object side of the lens system 100 and the two surfaces of the fourth lens 40 are aspherical. The fourth lens 40 can decrease astigmation and coma of the lens system 100.

The lens system 100 further includes an aperture stop 50 and an infrared filter 60. The aperture stop 50 is arranged between the first lens 10 and the second lens 20 in order to reduce light flux into the second lens 20. For cost reduction, the aperture stop 50 may be formed directly on the surface of the first lens 10 facing the image side of the lens system 100. In practice, a portion of the surface of the first lens 10 through which light rays should not be transmitted is coated with an opaque material, which functions as the aperture stop 50. The infrared filter 60 is arranged between the fourth lens 40 and the image plane 70 for filtering infrared rays coming into the lens system 100.

Further, the first lens 10, the second lens 20, the third lens 30, and the fourth lens 40 can be made from a resin or a plastic, which makes their manufacture relatively easy and inexpensive. In the present embodiment, the first lens 10, the second lens 20, the third lens 30, and the fourth lens 40 are made of glass.

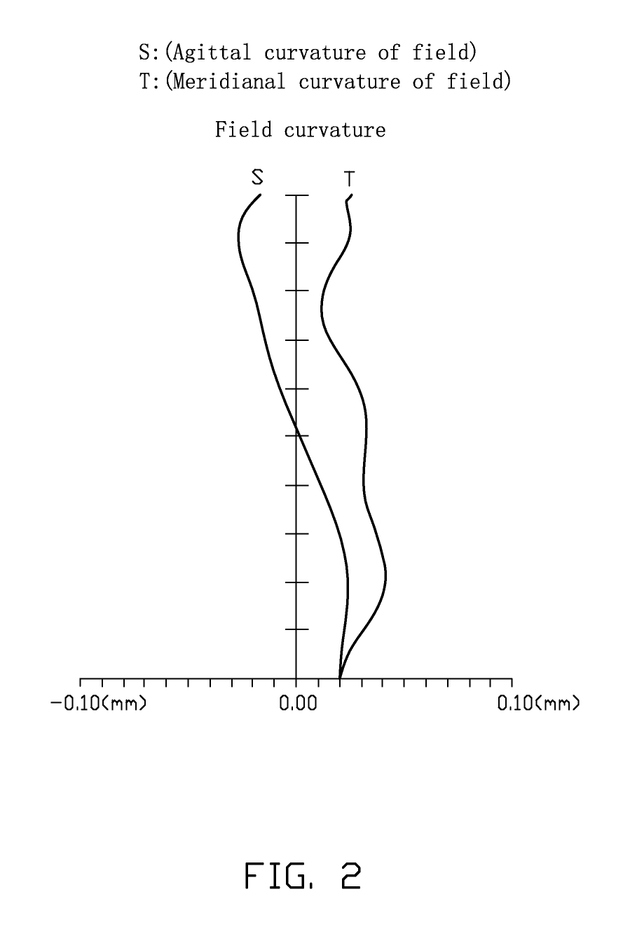

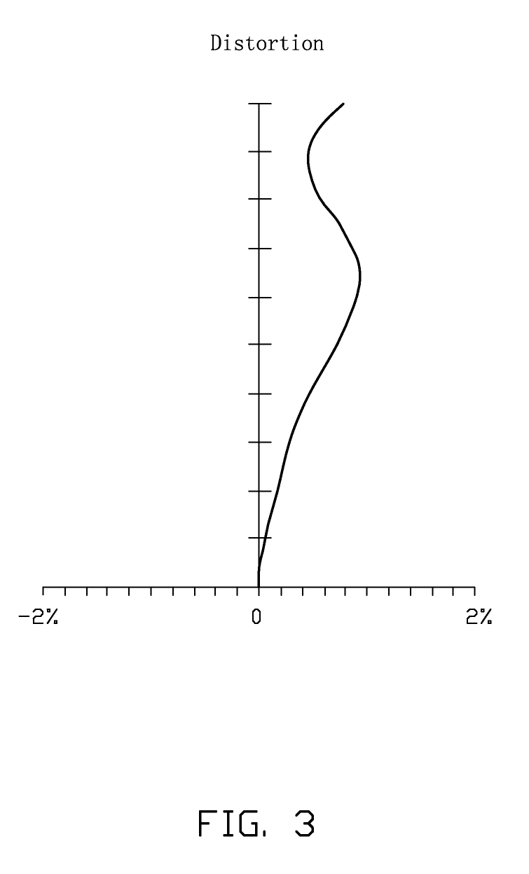

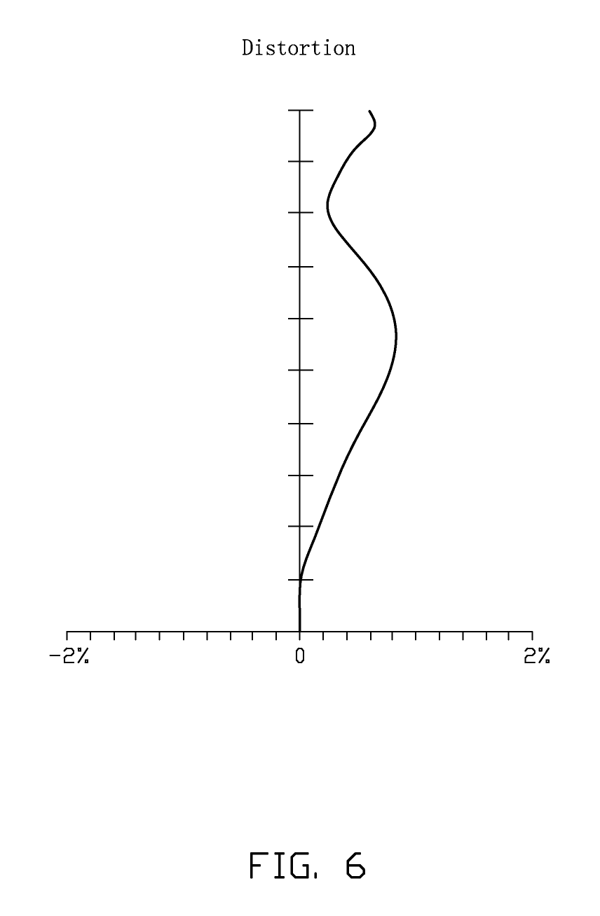

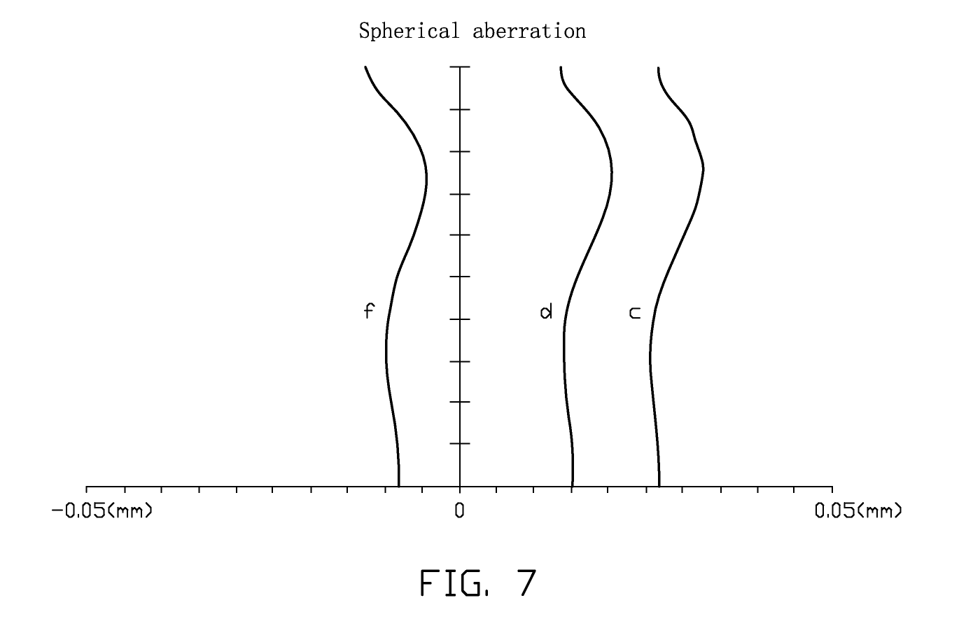

Examples of the system will be described below with reference to FIGS. 2-7. It is to be understood that the invention is not limited to these examples. The following are symbols used in each exemplary embodiment.

R: radius of curvature

d: distance between surfaces on the optical axis of the system

nd: refractive index of lens

V: Abbe constant

In each example, both surfaces of the first lens 10, both surfaces of the second lens 20, and both surfaces of the third lens 30 are aspheric, and both surface of the fourth lens 40 are aspheric. The field angle of the lens system 100 is 74°. The shape of each aspheric surface is determined by expression 1 below. Expression 1 is based on a Cartesian coordinate system, with the vertex of the surface being the origin, and the optical axis extending from the vertex being the x-axis.

$$x = \frac{{ch}^{2}}{1 + \sqrt{1 - ( k + 1 ) {c}^{2} {h}^{2}}} + \sum {A}_{i} {h}^{i} \qquad Expression 1$$

wherein, h is a height from the optical axis to the surface, c is a vertex curvature, k is a conic constant, and Ai are i-th order correction coefficients of the aspheric surfaces.

### EXAMPLE 1

Tables 1 and 2 show lens data of Example 1. In the table 2, A2 to A10 are aspherical coefficients.

TABLE 1

| Lens system 100 | R (mm) | d (mm) | nd | V |
|---|---|---|---|---|
| Object side surface of the | 1.66796 | 0.44359 | 1.543 | 56.803 |
| first lens 10 | | | | |
| Image side surface of the | 5.35002 | 0.06606 | — | — |
| first lens 10 | | | | |
| Object side surface of the second | −0.83057 | 0.30836 | 1.632 | 23.415 |
| lens 20 | | | | |
| Image side surface of the second | −1.13609 | 0.05 | — | — |
| lens 20 | | | | |
| Object side surface of the third | 19.79067 | 0.98973 | 1.543 | 56.803 |
| lens 30 | | | | |
| Image side surface of the third | −2.41796 | 0.051 | — | — |
| lens 30 | | | | |
| Object side surface of the fourth | 2.06183 | 0.48406 | 1.632 | 23.415 |
| lens 40 | | | | |
| Image side surface of the fourth | 1.35651 | 0.44986 | — | — |
| lens 40 | | | | |
| Object side surface of the infrared | infinite | 0.3 | 1.517 | 64.167 |
| filter 60 | | | | |
| Image side surface of the infrared | infinite | 1.19024 | — | — |
| filter 60 | | | | |

TABLE 2

| Surface | Aspherical coefficients |
|---|---|
| Object side surface of the first lens 10 | A2 = 0.144931; A4 = −0.0007; A6 = 0.002959; |
| | A8 = 0.000783; A10 = −0.0257 |
| Image side surface of the first lens 10 | A2 = −21.791; A4 = 0.0099296; A6 = −0.00649; |
| | A8 = −0.04499; A10 = 0.010268 |
| Object side surface of the second lens 20 | A2 = −0.41544; A4 = 0.0928443; A6 = 0.077831 |
| | A8 = 0.064621; A10 = 0.050432 |
| Image side surface of the second lens 20 | A2 = −0.31434; A4 = 0.0462758; A6 = 0.080848 |
| | A8 = 0.003354; A10 = 0.01697 |
| Object side surface of the third lens 30 | A2 = 62.30238; A4 = 0.0135616; A6 = 0.001598 |
| | A8 = −0.00454; A10 = 0.000788 |
| Image side surface of the third lens 30 | A2 = 0; A4 = 0.0429255; A6 = −0.00111 |
| | A8 = −0.00165; A10 = −0.00000490 |
| Object side surface of the fourth lens 40 | A2 = −12.4358; A4 = −0.033563; A6 = −0.00276 |
| | A8 = 0.000798; A10 = −0.00006018 |
| Image side surface of the fourth lens 40 | A2 = −6.06237; A4 = −0.034737; A6 = 0.001008 |
| | A8 = 0.000227; A10 = −0.00002367 |

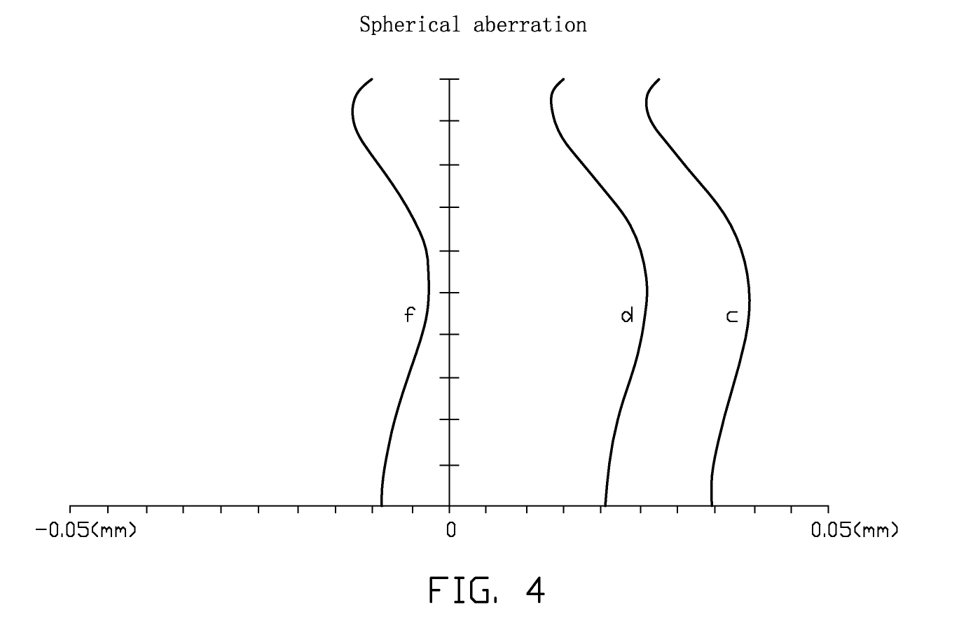

FIGS. 2-4 are graphs of aberrations (distortion, field curvature, and spherical aberration) of the lens system 100 of Example 1. In FIG. 4, the curves c, d, and f show spherical aberrations of the lens system 100 corresponding to three light wavelengths of 656.3 nm, 587.6 nm, and 435.8 nm respectively. Generally, the field curvature of the lens system 100 is limited to a range from −0.1 mm to 0.1 mm, the distortion of the lens system 100 is limited to a range from −2% to 2%, and the spherical aberration of lens system 100 is limited to a range from −0.05 mm to 0.05 mm.

### EXAMPLE 2

Tables 3 and 4 show lens data of Example 2. In the table 4, A2 to A10 are aspherical coefficients.

TABLE 3

| Lens system 100 | R (mm) | d (mm) | nd | V |
|---|---|---|---|---|
| Object side surface of the | 1.406081 | 0.642755 | 1.543 | 56.803 |
| first lens 10 | | | | |
| Image side surface of the | 3.657686 | 0.228189 | — | — |
| first lens 10 | | | | |
| Object side surface of the | −1.25147 | 0.507969 | 1.632 | 23.415 |
| second lens 20 | | | | |
| Image side surface of the | −2.54427 | 0.08 | — | — |
| second lens 20 | | | | |
| Object side surface of the | 7.841619 | 0.822438 | 1.543 | 56.803 |
| third lens 30 | | | | |
| Image side surface of the | −4.62433 | 0.206411 | — | — |
| third lens 30 | | | | |
| Object side surface of the | 1.810916 | 0.599514 | 1.632 | 23.415 |
| fourth lens 40 | | | | |
| Image side surface of the | 1.580273 | 0.288861 | — | — |
| fourth lens 40 | | | | |
| Object side surface of the | infinite | 0.3 | 1.517 | 64.167 |
| infrared filter 60 | | | | |
| Image side surface of the | infinite | 1.061139 | — | — |
| infrared filter 60 | | | | |

TABLE 4

| Surface | Aspherical coefficients |
|---|---|
| Object side surface of the first lens 10 | A2 = 0.076644; A4 = 0.014236; A6 = 0.001898 |
| | A8 = 0.020003; A10 = −0.0082 |
| Image side surface of the first lens 10 | A2 = 2.602214; A4 = 0.011151; A6 = 0.014871 |
| | A8 = −0.06502; A10 = 0.039439 |
| Object side surface of the second lens 20 | A2 = 0.055269; A4 = −0.1151; A6 = −0.01179 |
| | A8 = 0.265704; A10 = −0.51416 |
| Image side surface of the second lens 20 | A2 = 1.282484; A4 = −0.13023; A6 = 0.116593 |
| | A8 = −0.04159; A10 = 0.010979 |
| Object side surface of the third lens 30 | A2 = 6.197071; A4 = 0.01276; A6 = −0.00722 |
| | A8 = 0.001905; A10 = −0.00021 |
| Image side surface of the third lens 30 | A2 = −1.74211; A4 = 0.063196; A6 = −0.03239 |
| | A8 = 0.006817; A10 = −0.00061 |
| Object side surface of the fourth lens 40 | A2 = −4.59104; A4 = −0.04998; A6 = −0.00132 |
| | A8 = 0.00095; A10 = −0.00033 |
| Image side surface of the fourth lens 40 | A2 = −4.46459; A4 = −0.04504; A6 = 0.002886 |
| | A8 = −0.00025; A10 = −0.000008924 |

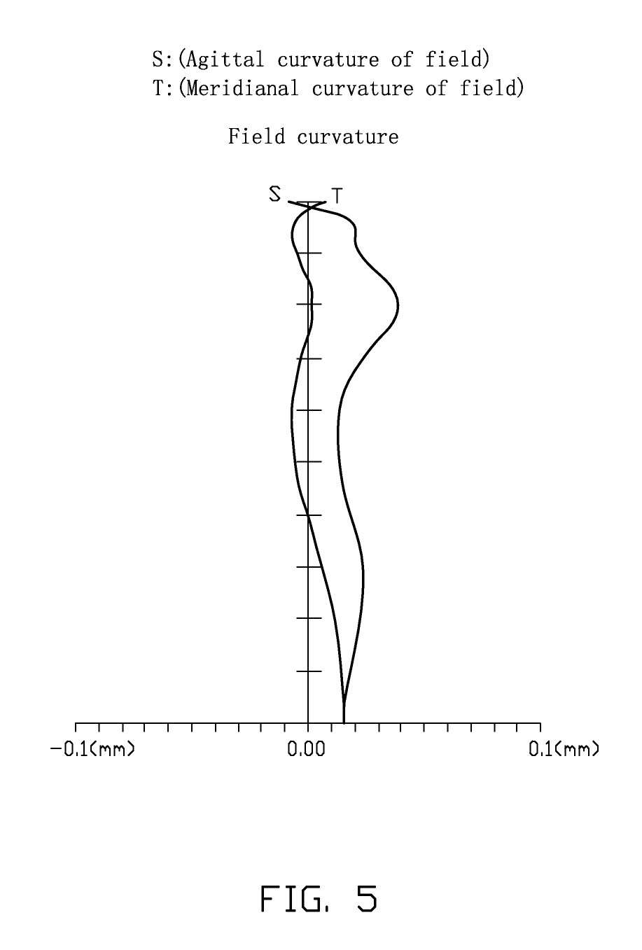

FIGS. 5-7 are graphs of aberrations (distortion, field curvature, and spherical aberration) of the lens system 100 of Example 1. In FIG. 4, the curves c, d, and f show spherical aberrations of the lens system 100 corresponding to three light wavelengths of 656.3 nm, 587.6 nm, and 435.8 nm respectively. Generally, the field curvature of the lens system 100 is limited to a range from −0.1 mm to 0.1 mm, the distortion of the lens system 100 is limited to a range from −2% to 2%, and the spherical aberration of lens system 100 is limited to a range from −0.05 mm to 0.05 mm.

As seen in the above-described examples, the distortion of the lens system 100 can also be limited to a range from −2% to 2%. The overall length of the lens system 100 is small, and the system 100 appropriately corrects fundamental aberrations.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

1. A lens system comprising, in order from the object side:
a positive refractive power first lens;
a negative refractive power second lens;
a positive refractive power third lens; and
a fourth lens,
wherein the lens system satisfies the following conditions:
(1) TTL/f<1.3;
(2) 0.75<f1/f<1.25, and 0.8<f3/f<1.6,
wherein, TTL is a distance from a surface of the first lens facing the object side of the lens system to an image plane, f is a focal length of the lens system, f1 is a focal length of the first lens, and f3 is a focal length of the third lens.

2. The lens system as claimed in claim 1, wherein the following condition is satisfied:
(3) V1>50, wherein, V1 is the Abbe constant of the first lens.

3. The lens system as claimed in claim 1, wherein the following condition is satisfied:
(4) n2>1.58, wherein, n2 is the refractive index of second lens.

4. The lens system as claimed in claim 1, wherein the following condition is satisfied:
(5) 0.9<|f2/f|<2.2, wherein, f2 is a focal length of the second lens.

5. (canceled)

6. The lens system as claimed in claim 1, wherein the lens system further comprises an aperture stop arranged between the first lens and the second lens.

7. The lens system as claimed in claim 6, wherein the aperture stop is formed directly on the surface of the first lens facing the image side of the lens system.

8. The lens system as claimed in claim 7, wherein the aperture stop is formed by coating a peripheral portion of the surface of the first lens using an opaque material.

9. The lens system as claimed in claim 1, wherein the lens system further comprises an infrared filter arranged between the fourth lens and an image plane of the lens system.

10. The lens system as claimed in claim 1, wherein the first lens is a meniscus-shaped lens with a convex surface facing the object side of the lens system.

11. The lens system as claimed in claim 1, wherein the second lens is a meniscus-shaped lens with a convex surface facing the image side of the lens system.

12. The lens system as claimed in claim 1, wherein the third lens is a biconvex lens.

13. The lens system as claimed in claim 1, wherein the lens surface configuration of the fourth lens near the optical axis of the lens system is meniscus-shaped with a convex surface facing the object side of the lens system.

14. The lens system as claimed in claim 1, wherein each of the first lens, the second lens, the third lens, and the fourth lens is an aspherical lens.

15. An device with image capturing function, comprising:
a body;
a lens module mounted on the body, the lens module comprising, in order from the object side:
a positive refractive power first lens;
a negative refractive power second lens;
a positive refractive power third lens; and
a fourth lens,
wherein the lens system satisfies the following conditions:
(1) TTL/f<1.3;
(2) 0.75<f1/f<1.25, and 0.8<f3/f<1.6,
wherein, TTL is a distance from a surface of the first lens facing the object side of the lens system to a image plane, f is a focal length of the lens system, f1 is a focal length of the first lens, and f3 is a focal length of the third lens; and
an image plane mounted in the body and arranged on the image side of the lens module.

16. The device as claimed in claim 15, wherein the following condition is satisfied: (3) V1>50, wherein, V1 is the Abbe constant of the first lens.

17. The device as claimed in claim 15, wherein the following condition is satisfied: (4) n2>1.58, wherein, n2 is the refractive index of second lens.

18. The device as claimed in claim 15, wherein the following condition is satisfied: (5) 0.9<|f2/f |>2.2, wherein, f2 is a focal length of the second lens.

19. (canceled)

20. The device as claimed in claim 15, wherein the lens module further comprises an aperture stop arranged between the first lens and the second lens.
